(19) United States
(12) Patent Application Publication
(10) Pub. No.: US 2026/0004943 A1
(43) Pub. Date: Jan. 1, 2026

(54) DILUTE RADIONUCLIDE CONCENTRATION ENHANCEMENT THROUGH DISTILLATION

(71) Applicant: TerraPower, LLC, Bellevue, WA (US)

(72) Inventors: Phillip I. Johnson, Eugene, OR (US); Sally A. Miller, Seattle, WA (US)

(21) Appl. No.: 19/257,316

(22) Filed: Jul. 1, 2025

Related U.S. Application Data
(60) Provisional application No. 63/666,241, filed on Jul. 1, 2024.

(51) Int. Cl. G21C 17/025; G01T 1/16; G21C 15/28; G21C 17/10

(52) U.S. Cl. CPC G21C 17/025; G01T 1/16; G21C 15/28; G21C 17/10

(57) ABSTRACT

In a sodium-cooled fast reactor, a breached fuel pin releases fission and activation products into the primary sodium coolant and into the cover gas. A portion of the primary sodium coolant is diverted to a distillation system where its constituents can be separated based on volatility. Condensing these constituents enables precise measurement of their concentration without delays caused by waiting for the decay of radioactive sodium background scatter, enhancing the detection and quantification of the dilute constituents. Additionally, the method continuously determines the initial concentration of constituents in the feed. Quantification is achieved using detectors, facilitating the continuous assessment of dilute constituent concentrations in the sodium coolant feed stream.

### GOVERNMENT LICENSE RIGHTS

This invention was made with government support under DOE Cooperative Agreement No. DE-NE0009054 awarded by the U.S. Department of Energy. The government has certain rights in the invention.

### BACKGROUND

In a sodium-cooled fast reactor (“SFR”), the reactor components include a reactor vessel filled with a liquid sodium coolant and a reactor core. The reactor core is immersed in the sodium pool in the reactor vessel. In some designs, the core may include fuel pins bundled into fuel assemblies that contain fissile fuel and fertile fuel that may be bred up into fissile fuel. Within the reactor core, the fuel pins undergo significant stress and strain due to mechanical stresses and strains as well as due to thermal stresses, neutron damage, and internal fuel pin forces due to fissioning. In some cases, one or more of the fuel pins may fail, such as by leaking fertile fuel, fissile fuel, and/or fission products into the primary sodium.

Typically, a fuel pin failure is a breach in the fuel pin cladding that allows direct contact between the primary coolant and the nuclear fuel. This contact may cause a reaction between the fuel and the sodium, and in some cases, can lead to the formation of an uranoplutonate phase which can further lead to fuel swelling and the potential for further degradation of the fuel pin. Furthermore, fission products can leech out of the fuel. In particular, liquid cesium and cesium vapor can be ejected upon a pin failure.

Typically, delayed neutrons and cover gas analysis have been used for detecting the presence of a failure. However, locating the failed fuel element can be problematic. For example, triangulation using delayed neutron detectors, tag gas, flux tilting, sodium sampling, wet sipping, and dry sipping are all techniques that have been tried to varying degrees of success.

For instance, dry sipping requires a fuel assembly to be lifted completely out of the sodium pool and allowed to heat up in a sealed container, disrupting the cooling. This can be supplemented by pulling a vacuum on the fuel assembly to create a greater pressure differential to “burp” the fuel assembly. Wet sipping requires the fuel pin to be pressurized in order to vent fission gasses. Wet sipping typically occurs by blocking the outlet of an assembly to reduce cooling which will heat and build pressure within the fuel pins. Failed fuel pins will push out additional fission product inventory that can subsequently be sampled. Sodium sampling allows a fuel pin to remain in place and a sodium sample is taken from above the fuel assembly and analyzed using delayed neutron detectors. However, each of these methods has disadvantages and are exacerbated by the large background scatter peaks associated with the primary coolant, which tends to mask the peaks of dilute constituents within the primary coolant. It would be advantageous to be able to ascertain the presence of a failed fuel pin and the content of the primary coolant without waiting for the background scatter of the primary coolant to decay.

### SUMMARY

According to some embodiments, a method for online monitoring of radionuclides in a sodium coolant, comprises flowing a continuous sodium coolant stream to a distillation apparatus; distilling one or more constituents of the sodium coolant stream to separate a distillate; and determining a concentration of the distillate in the sodium coolant stream.

In some examples, one of the enriched components of the distillate is cesium and determining a concentration of the distillate further comprises determining an isotopic ratio of ¹³⁷Cs/¹³⁴Cs within the sodium. The method may include determining, based at least in part on the isotopic ratio, the burnup of the failed fuel assembly. The burnup may be determined based upon the isotopic ratio of ¹³⁷Cs/¹³⁴Cs. In some embodiments, the method includes determining, based at least in part on the burnup, an identification of the failed fuel assembly. While the individual failed fuel assembly may not be readily identifiable based on the isotopic ratio, the identification of the failed fuel assembly may be down selected based upon the burnup to result in a subset of fuel assemblies that likely includes the failed fuel assembly.

In some cases, determining the concentration of the distillate in the sodium coolant stream is performed by gamma spectroscopy. The distillate, by virtue of the distillation process, may be concentrated up to three orders of magnitude or more over the initial concentration of the distillate in the primary coolant stream. In many cases, the distillation process provides a concentrated constituent that provides immediate spectrographic results in real time. That is, the results may be obtained without needing to wait for background scatter to reduce in order to ascertain the distillate levels. This allows accurate readings within seconds or minutes, rather than waiting days for background scatter to reduce. In some cases, results can be obtained depending on the residence times in the distillation column. As the column products will respond to an inlet concentration change with a delay that depends on flows, size, and geometry. Nevertheless, results may typically be obtained much faster than traditional methods of waiting for sodium background scatter to decay before the ability to obtain a meaningful reading of the dilute constituents in the sodium coolant. The dilute constituents may be found in the distillate or in the bottoms product, which may both be further analyzed for dilute constituent concentrations.

The method may be performed without removing primary sodium coolant from a closed system comprising a nuclear reactor vessel and a sodium flow pipe. The method may further include the step of determining, by analyzing a cover gas in a reactor vessel and detecting a fission product in the cover gas, that a fuel assembly has failed. This determination may then signal that a portion of the primary coolant may need to be distilled to concentrate one or more constituents.

In some cases, the method includes providing a tag gas to one or more fuel elements within a fuel assembly, which may be used to further identify a failed fuel assembly. Providing a tag gas may include providing a plurality of unique tag gases and wherein a number of unique tag gases is less than a number of fuel assemblies located within a nuclear reactor core.

In some cases, the method is carried out during reactor operation, and may include determining a concentration of the distillate in the sodium coolant stream in real time without waiting for radioactive sodium to decay.

In some examples, determining an identification of the failed fuel assembly comprises determining a subset of fuel assemblies, the subset of the fuel assemblies comprising one or more of the failed fuel assemblies. This may be accomplished through determining burnup and/or identification of a released tag gas. The method may further include analyzing ones of the subset of the fuel assemblies to determine a failed fuel assembly. Analyzing ones of the subset of the fuel assemblies may include a lift and burp technique.

According to some embodiments, a system includes a nuclear reactor core; a plurality of fuel elements disposed in the nuclear reactor core; a volume of primary sodium coolant in contact with the plurality of fuel elements; a distillation apparatus in fluid communication with the nuclear reactor core by sodium processing piping and configured to concentrate one or more constituents of the primary sodium coolant to separate by distillation; a detector adjacent the sodium processing piping, the detector configured to detect radioactive emissions of distillation products that escaped from a failed fuel assembly into the primary coolant; and one or more processors configured with instructions that, when executed by the one or more processors, cause the processors to determine a concentration of one or more constituents in the primary sodium coolant.

The one or more processors may be further configured to determine isotopic ratios of the distillates; determine, based at least in part on the isotopic ratios, a burnup of the failed fuel assembly; and determine, based at least in part on the burnup of the failed fuel assembly, a location of the failed fuel assembly within the nuclear reactor core. The isotopic ratio may be ¹³⁷Cs/¹³⁴Cs.

The system may further include a plurality of unique tag gases located within selected ones of the plurality of fuel elements disposed in the nuclear reactor core.

In some cases, the detector is configured to detect gamma emissions from the isotopes that escaped from a failed fuel assembly through gamma spectroscopy.

The distillate may include cesium.

In some cases, burnup is determined by using gamma spectroscopy to detect an isotopic ratio. The method may be performed in-situ and without removing a volume of sodium coolant from the nuclear reactor core. In some cases, determining that a fuel assembly has failed is performed by analyzing a cover gas in a reactor vessel and detecting a fission product in the cover gas.

In some examples, using a tag gas comprises providing a first tag gas to a first group of fuel assemblies, providing a second tag gas to a second group of fuel assemblies, and providing a third tag gas to a third group of fuel assemblies.

The method may be carried out during reactor operation. In some cases, the method further includes the step of analyzing the second subset of fuel assemblies using a lift and burp technique.

### BRIEF DESCRIPTION OF THE DRAWINGS

The accompanying drawings are part of the disclosure and are incorporated into the present specification. The drawings illustrate examples of embodiments of the disclosure and, in conjunction with the description and claims, serve to explain, at least in part, various principles, features, or aspects of the disclosure. Certain embodiments of the disclosure are described more fully below with reference to the accompanying drawings. However, various aspects of the disclosure may be implemented in many different forms and should not be construed as being limited to the implementations set forth herein. Like numbers refer to like, but not necessarily the same or identical, elements throughout.

The following drawing figures, which form a part of this application, are illustrative of described technology and are not meant to limit the scope of the technology as claimed in any manner, which scope shall be based on the claims appended hereto.

FIG. 1 illustrates a partial cutaway perspective view of a nuclear fission reactor, in accordance with some embodiments.

FIG. 2 is a top sectional view of a reactor core for a nuclear fission reactor, in accordance with some embodiments.

FIG. 3A is a partial elevation view of a nuclear fission reactor core, according to some embodiments.

FIG. 3B illustrates a fuel element with fuel and a tag gas capsule located therein, in accordance with some embodiments.

FIG. 4 illustrates, in a block diagram form, a sodium cooled fast reactor with a sampling sub-cell as part of the sodium processing system, in accordance with some embodiments.

FIG. 5 is a graph depicting radioactivity of Cesium-134 and Cesium-137 versus burnup, in accordance with some embodiments.

FIG. 6 illustrates a process for online radioisotope measurement for in-cell failed fuel characterization, in accordance with some embodiments.

FIG. 7 is a graph showing mass ratios of Xenon isotopes versus burnup, in accordance with some embodiments.

FIG. 8 illustrates a process for identifying and locating a failed fuel assembly within a nuclear reactor core, in accordance with some embodiments.

FIG. 9 illustrates a McCabe-Thiele Diagram showing the vapor-liquid equilibrium of cesium, in accordance with some embodiments.

FIG. 10 illustrates a block diagram showing the flow of primary coolant, in accordance with some embodiments.

FIG. 11 illustrates a block diagram illustrating components of a system, in accordance with some embodiments.

FIG. 12 illustrates a process for distilling one or more constituents of a primary coolant, in accordance with some embodiments.

### DETAILED DESCRIPTION

The disclosure sets forth example embodiments and, as such, is not intended to limit the scope of embodiments of the disclosure and the appended claims in any way. Embodiments have been described above with the aid of functional building blocks illustrating the implementation of specified functions and relationships thereof. The boundaries of these functional building blocks have been arbitrarily defined herein for the convenience of the description. Alternate boundaries can be defined to the extent that the specified functions and relationships thereof are appropriately performed.

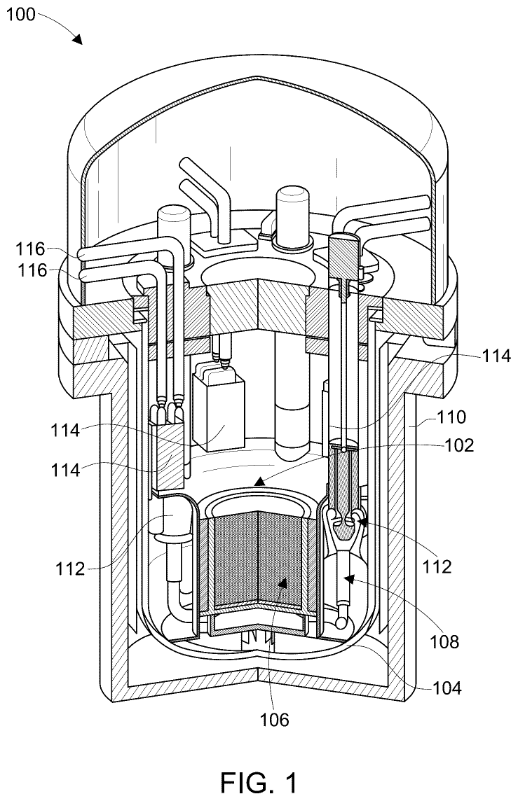

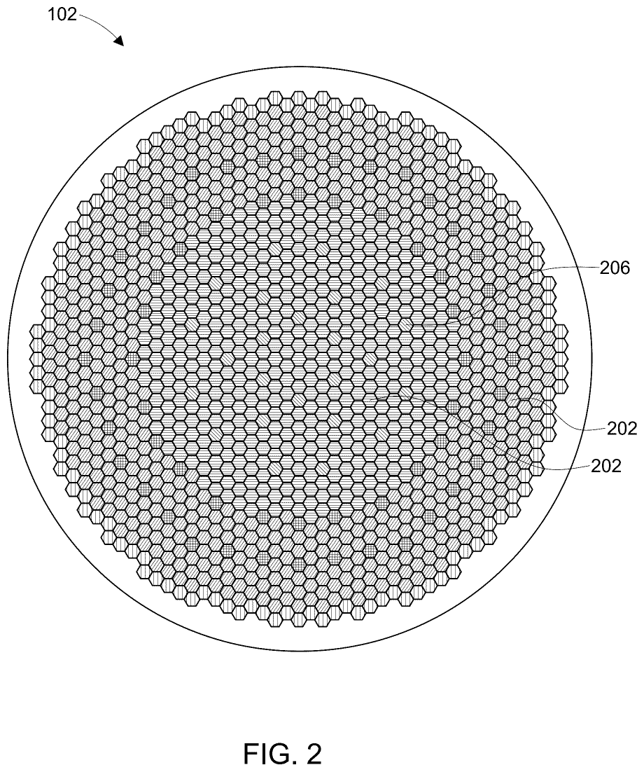

FIGS. 1 and 2 illustrate a fission reactor and reactor core as a non-limiting overview and not by way of limitation. As shown, nuclear fission reactor 100 includes a nuclear fission reactor core 102 disposed in a reactor vessel 104. According to some embodiments, nuclear fission reactor core 102 contains nuclear fuel within a central core region 106. The reactor core 102 may include nuclear fuel assemblies with fissile and/or fertile fuel 202, and movable reactivity control assemblies 206. According to some embodiments, an in-vessel handling system (not shown) is configured to shuffle ones of the fissile nuclear fuel assemblies 202 and ones of the fertile nuclear fuel assemblies 204 within the reactor core 102. Nuclear fission reactor 100 may also include a reactor coolant system 108.

In some implementations, the nuclear fission reactor 100 is based on elements of liquid metal-cooled, fast reactor technology. For example, in various embodiments the reactor coolant system 108 includes a pool of liquid sodium disposed in the reactor vessel 104. In such cases, the nuclear fission reactor core 102 is submerged in the pool of sodium coolant in the reactor vessel 104. The reactor vessel 104 may be surrounded by a containment vessel 110 that helps prevent loss of sodium coolant in the unlikely case of a leak from the reactor vessel 104.

In various embodiments, the reactor coolant system 108 includes a reactor coolant pump 112. The reactor coolant system 108 may include one pump, two pumps, or any suitable number of pumps. In addition, the pumps may be any suitable pump as desired (e.g., electromechanical, electromagnetic, etc.).

The reactor coolant system 108 may include one or more heat exchangers 114. Heat exchangers 114 may be disposed in the pool of liquid sodium. In some embodiments, heat exchangers 114 have non-radioactive intermediate sodium coolant on the other side of heat exchangers 114. To that end, heat exchangers 114 may be considered intermediate heat exchangers.

The pumps 112 may be configured to circulate primary sodium coolant through the nuclear fission reactor core 102. In some embodiments, the pumped primary sodium coolant exits the nuclear fission reactor core 102 at a top of the nuclear fission reactor core 102 and passes through one side of the heat exchangers 114. In some embodiments, heated intermediate sodium coolant is circulated via intermediate sodium loops 116 outside the containment vessel 110, such as to a steam generator, to a thermal storage system, or may be circulated to heat exchangers for still another use. The primary sodium coolant may be circulated within the reactor vessel, through the reactor core and through the fuel assemblies, and a volume of primary sodium may be sent beyond the reactor vessel to a sodium processing cell, as will be described in further detail.

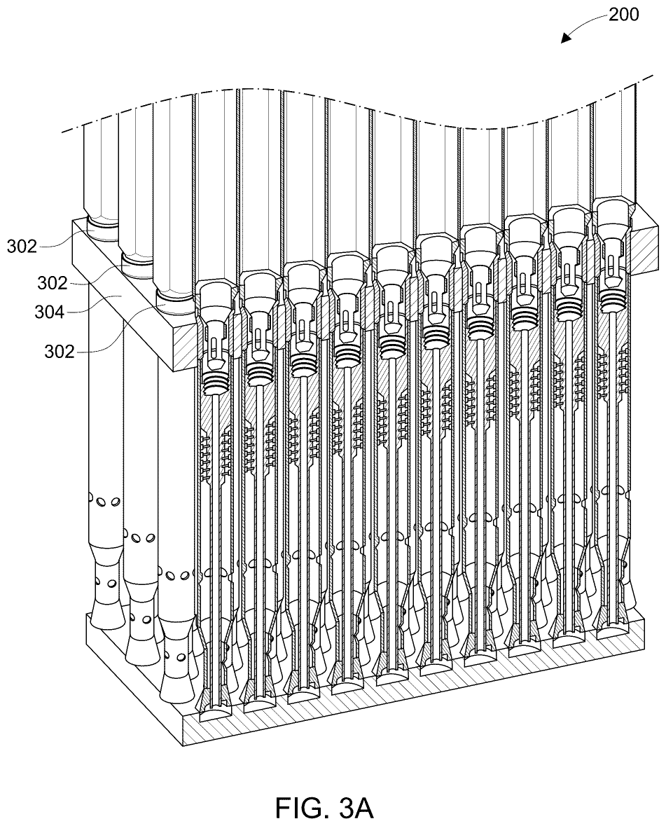

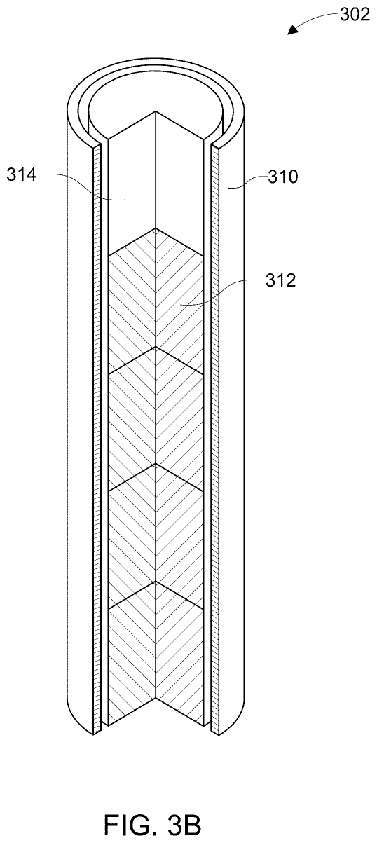

FIG. 3A illustrates a nuclear fission reactor core 100 that includes a plurality of nuclear fuel assemblies (e.g., fissile nuclear fuel assemblies 202, fertile nuclear fuel assemblies 204, movable reactivity control assemblies 206, etc.), shown as fuel assemblies 302. In some embodiments, fuel assemblies 302 may be supported in part by a core support grid plate 304. Primary sodium coolant flows through fuel assemblies 302, according to some embodiments to absorb heat generated by fuel within the fuel assemblies undergoing fission reactions.

In some embodiments, fuel assembly 302 includes a plurality of nuclear fuel pins (e.g., fuel rods, fuel elements, etc.), disposed within a duct that includes a tubular body. In some cases, the tubular body has a hexagonal cross-sectional shape as shown in FIGS. 2 and 3. In use, the primary sodium coolant flows upwardly into the fuel assemblies and around the fuel elements therein and draws heat away from the fuel assemblies and to the heat exchangers.

FIG. 3B illustrates a portion of a fuel element, which are typically long, slender bodies including a thin-walled outer jacket, or cladding 310. It should be appreciated that fuel element 302 need not be neutronically active. In some cases, the fuel element 302 need not contain any fissile material, but rather, may include neutronically reflective material, or fertile material, or a combination. In some cases, the fuel element 302 may contain fuel slugs 312 that may be stacked. Of course, the fuel element may contain any suitable fuel material and morphology, including extruded, annular, sponged, oxide, metal, among other types and shapes of nuclear fuel. In some cases, a tag gas capsule 314 may contain a tag gas (i.e., an identifying gas or mixtures of gasses). According to some embodiments, the tag gas capsule 314 may be loaded with specially blended gasses, such as one or more of isotopes of krypton or xenon isotopes. In some examples, once the tag gas capsules 314 are loaded into the fuel elements 302 and sealed, the tag gas capsules 314 may be pierced to allow the tag gas within the capsule to escape into the fuel element. In this way, if the fuel element 302 ever develops a leak, the tag gas may be released, and the defect core assembly can be located according to the embodiments described herein. In some cases, the tag gas capsule 314 may be formed into an end cap, or may be disposed internal to the fuel assembly. According to some embodiments, the tag gas capsule 314 releases its gas contents upon the fuel assembly reaching a desired temperature, thus the tag gas capsule 314 may remain intact until the fuel assembly is disposed within an operating nuclear reactor core. At a time after installation in the fuel assembly, the tag gas capsule 314 may be ruptured, pierced, breached, or otherwise unsealed to allow the tag gas to flow into the fuel assembly.

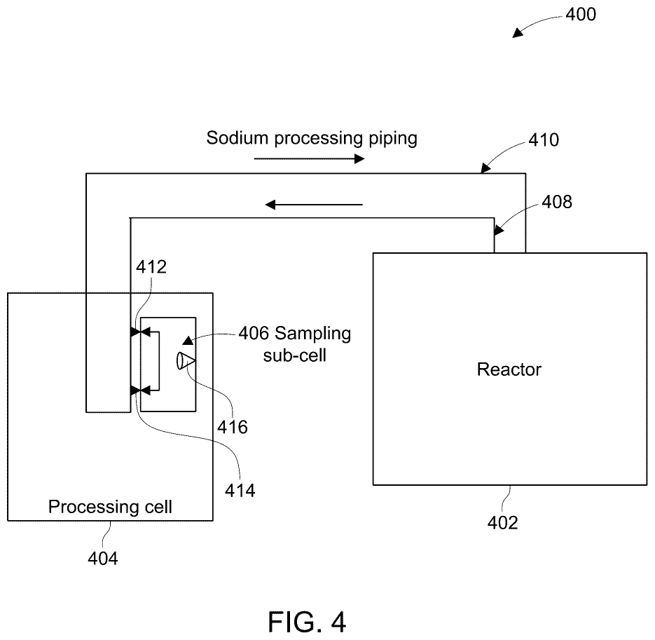

FIG. 4 illustrates a system 400 that includes a sodium-cooled nuclear reactor 402. The nuclear reactor 402 has a reactor core in which fuel elements are disposed. As shown in relation to FIG. 3, fuel elements are typically long, slender bodies including a thin-walled, outer jacket (also called cladding) and a fertile and/or fissionable composition (including fissionable nuclear fuel) within the cladding. Depending on the design of the nuclear reactor, multiple fuel elements are typically co-located into a fuel bundle or fuel assembly, and multiple fuel assemblies are included in the nuclear reactor. The geometric shape of the fuel element can be any suitable shape designed for the physical and design constraints of the fuel assembly and the nuclear reactor.

In conventional nuclear reactors, during irradiation in the reactor core, the fuel expands due to, for example, the production of fission products and, in particular, fission products in the form of gas. The fuel expands within the available space of the inner diameter of the cladding of an individual fuel element. However, over time and at higher burnup values, the expansion of the fuel can strain the cladding, particularly where gas retention occurs and when fission products (gas or solid) begin to fill voids within the fuel. At this point, cladding strain may become proportional to burnup and cladding strain may begin to increase rapidly. The filling of the available space within the cladding leads to a buildup of pressure that results in hoop stress, longitudinal stress and strain, and deformation of the fuel element. This strain ultimately limits the life of fuel elements in the reactor core as expansion of the fuel cladding leads to decreased (sometimes non-uniform) coolant flow areas external to the cladding. The rate of strain is increased by the constant effect of radiation on the structural material (e.g., cladding material and fuel assembly ducts). The fuel elements can expand enough to impart further strain on the duct wall of their associated fuel assemblies, which may become ‘jammed’ together due to the swelling and/or cause bowing of the fuel assembly. The fuel element swelling may sometimes cause cracks in the cladding which can lead to uncontrolled release of fission products and/or coolant interaction with the fuel. In a sodium cooled fast reactor, for example, liquid sodium flows around the fuel elements and where a fuel element fails (e.g., cracks or otherwise ruptures), the sodium coolant contacts the fuel and interacts with the fuel and fission products.

In some embodiments, the sodium travels from the reactor 402 through a sodium outlet pipe 408 to a sodium processing cell 404. A sampling sub-cell 406 may be located within the processing cell 404 for measuring emissions from a sodium sample. After measurements are taken, the sodium may travel through a sodium inlet pipe 410 back to the reactor 402. In some cases, the sodium flow loop from the reactor 402, through the outlet pipe 408, through the sodium processing cell 404, and back to the reactor 402 through the sodium inlet pipe 410 is a closed fluid system. As used herein, a closed fluid loop or closed fluid system refers to pipes, valves, pumps, and other fluid transport apparatus that is closed to the ambient environment. A closed fluid loop is one in which the fluid does not leave the system and returns to the reactor vessel and the primary coolant inventory.

In some cases, the sampling sub-cell 406 may be configured to isolate a sodium sample, such as by valves 412, 414 that allow sodium to flow into the sub-cell 406 and then be isolated therein by closing the valves 412, 414. The sampling sub-cell 406 may contain a radiation detector/spectrometer 416 positioned near and/or adjacent to the pipe within the sampling sub-cell 406 in order to measure radiation emitted from the sodium sample in the pipe. The valves 412, 414 allow the pipe to be isolated, among other reasons, to allow short lived isotopes (e.g., ²⁴Na) to decay in order to reduce background signals. In some cases, the radiation detector 416 is configured to measure gamma emissions from the sodium in the sampling sub-cell 406.

According to some embodiments, a method for characterizing failed fuel in sodium fast reactors (SFRs) uses measurements of gamma emissions to determine isotopic quantities and ratios of failed fuel products in the primary sodium coolant. By allowing sodium coolant to flow to the sodium processing cell 404 and into the sampling sub-cell 406, a failed fuel assembly can be characterized without the need to pull, process, and analyze primary sodium samples physically drawn from the reactor coolant for characterization of failed fuel products.

As used herein, a “failed fuel assembly” or “failed fuel element” refers to a fuel assembly or fuel element that has developed a breach, crack, rupture, or other defect in its cladding that allows direct contact between the nuclear fuel material and the primary coolant. This breach permits the release of fission products, activation products, fission gases, and/or tag gases from within the fuel element into the primary coolant and/or cover gas. A fuel assembly is considered failed when any fuel element within that assembly experiences such a cladding breach. The failure may result from mechanical stresses, thermal stresses, neutron damage, internal pressure from fission gas accumulation, fuel-coolant chemical interactions, or other degradation mechanisms that compromise the integrity of the fuel cladding.”

Typical prior approaches to characterizing failed fuel included removal of primary sodium samples for radioisotope analysis. These methods required handling of radioactive primary sodium, necessary sodium sample preparation equipment, generation of hazardous and radioactive wastes during sample processing, and time taken to analyze samples of primary sodium. Other prior approaches required removing the fuel assemblies from the reactor core in order to detect leakage.

According to some embodiments, characterizing failed fuel can be done in-situ by characterizing radioisotopes in primary sodium that has passed to the sampling sub-cell 406 which can be used for determining isotopic ratios of failed fuel constituents present in the primary coolant. This allows for determining the burnup of the failed fuel assembly, which in turn, can be correlated to a location of the failed fuel assembly within the core. As used herein, the term “burnup” is a broad term and refers to the measure of how much energy has been extracted from the nuclear fuel during its irradiation in a nuclear reactor. The burnup of the fuel assembly may be quantified in terms of the total energy produced per unit mass of fuel, which may be expressed in megawatt-days per metric ton of heavy metal (MWd/MTU). This metric accounts for both the depletion of fissile isotopes and the building of fission products and neutron absorbers, which gradually reduce the reactor's reactivity over time. Several factors influence the burnup of a fuel assembly, including reactor operating conditions, neutron flux, fuel composition, and fuel management strategies. As the burnup increases, the concentration of fissile isotopes decreases. Thus, determining a ratio of ¹³⁷Cs to ¹³⁴Cs provides strong correlation of burnup of a fuel assembly that is leaking sodium. In turn, the burnup can be used, in conjunction with core modeling and/or fuel assembly tracking, to determine a group of fuel assemblies that are likely candidates for releasing the cesium into the primary coolant.

As used herein, the term “burnup,” also referred to as “% FIMA” (fissions per initial heavy metal atom) may also refer to a measure (e.g., a percentage) of fission that occurs in fissile fuel. For example, a burnup of 5% may indicate that 5% of the fissionable fuel underwent a fission reaction. Due to a number of factors, burnup may not occur evenly along the length of each individual fuel element in a fuel assembly. Similarly, different fuel elements and fuel assemblies will each have different burnups based upon factors such as location in the core, length of time in the core, length of time at various locations within the core, volume of fuel in the assembly, fuel enrichment, among others. A fuel element is considered exhausted when a region of the fuel element has undergone enough burnup to reach a burnup limit, also sometimes referred to as a “peak burnup” or “maximum burnup.” When any one location reaches the burnup limit, the entire fuel element is considered discharged even though only a portion of the fuel within that element has actually reached the discharge limit. In contrast to peak or maximum burnup, the term “actual burnup” may be used herein to refer to an amount of burnup that has occurred within a defined area of the fuel assembly at the time when the fuel element is considered discharged because at least a portion of the fuel within the fuel element has reached the burnup limit. According to embodiments herein, the isotopic ratios of failed fuel constituents may be used to determine isotopic ratios corresponding with either peak burnup, actual burnup, and/or average burnup of a fuel element.

Traditionally, gas tagging is a method that has been used to identify a failed fuel element and includes the addition of a small amount of gas to a fuel element with a unique isotopic composition for each fuel assembly. When a fuel assembly develops a leak and releases fission products from the pressurized fuel element into the primary coolant, the tag gas can be detected, such as by mass spectrometric analysis of the reactor vessel cover gas. For example, gas tagging may utilize inert gases such as krypton and xenon. The unique tag gas compositions could be achieved with preferential enrichment of any of a number of isotopes, such as ⁷⁸Kr, ⁸⁰Kr, ⁸²Kr, ¹²⁶Xe, and ¹²⁹Xe to name a few. The isotopic ratios could be used, such as ⁷⁸Kr/⁸⁰Kr, ⁸²Kr/⁸⁰Kr, or ¹²⁶Xe/¹²⁹Xe to determine which of the fuel assemblies has failed. This technique may be successful in identifying a failed fuel element and a location; however, tag gas manufacture is expensive, especially considering that each fuel assembly requires a unique tag gas, and thus, each fuel assembly requires a unique manufacturing process. In some cases, this requires up to 168 or more unique tag gases in order to provide a unique tag gas for each fuel assembly.

According to some embodiments, high burnup fuels are utilized in the fuel assemblies and the tag system that is typically used is not viable on high burnup fuels due to the reduction of the band gaps between the different numerous tag gases. For example, on past reactors, the tag gases became indistinguishable since the tag gas was being directly depleted and fission products (such as Xe and Kr) also changed the composition. Embodiments described herein, such as the isotopic cesium ratios, allow down sampling of the possible failed fuel assemblies to a much smaller subset of possible fuel assemblies. Furthermore, using fewer tag gases than there are fuel assemblies offers a significant cost savings, but perhaps more importantly, offers a tag gas system that is able to be used with high-burnup fuels, as the traditional tag gas system fails in a high-burnup fuel. As used herein, the term “high-burnup fuel” is a broad term and in some cases, refers to a fuel with greater than around 6% FIMA.

However, according to embodiments described herein, fission gases are able to identify a failed fuel assembly without requiring a unique tag gas to be manufactured into each fuel assembly, thus drastically simplifying the manufacture of fuel elements, which may all be manufactured to be nearly identical using the same materials and processes. For example, by using fewer tag gases than there are fuel assemblies, larger bands (i.e., initial mass differences of the tag gasses) are used so that higher levels of depletion and fission gas additions will continue work to determine a failed fuel assembly even with a lower number of unique tag gasses. According to some embodiments, a lower number of unique tag gasses is enabled by having additional metrics, such as direct fission product sampling, to allow a further down selection of the failed fuel assembly.

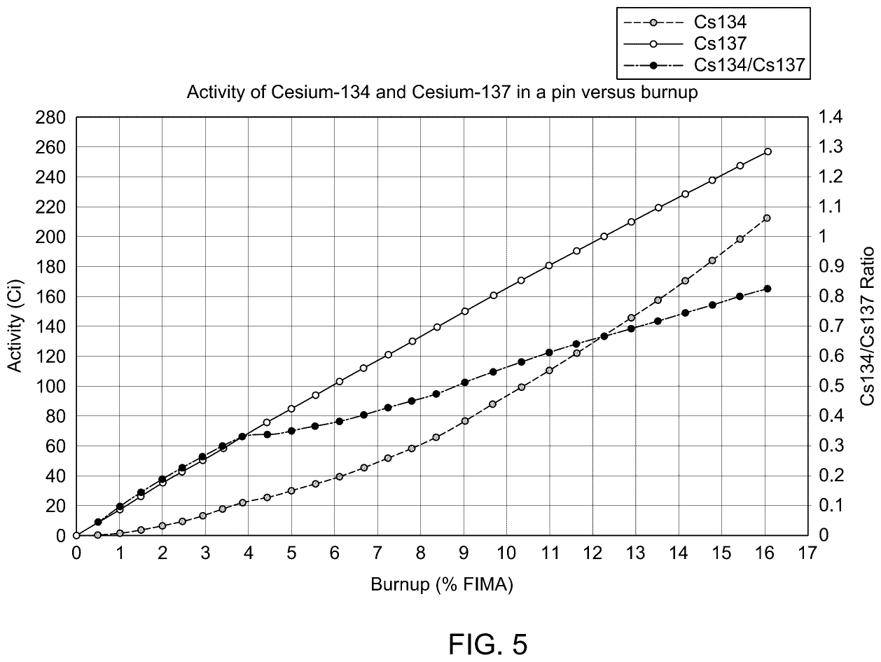

FIG. 5 illustrates a graph of ¹³⁷Cs/¹³⁴Cs as a function of burnup. As shown, ¹³⁷Cs exhibits a linear activity as a function of burnup. In contrast, ¹³⁴Cs is non-linear, which allows a measured ratio of ¹³⁷Cs/¹³⁴Cs to correspond with a specific fuel burnup within a fuel assembly. A mass spectrometer can be used to measure the mass of ¹³⁷Cs and ¹³⁴Cs, determine the isotopic ratio, and based on the isotopic ratio, determine a fuel burnup. Through core tracking and modeling, the burnup can be correlated with an individual fuel assembly.

While the isotopic ratio may be determined by mass spectroscopy, gamma ratios may also be used to determine activity, which is linked to burnup, and ultimately, identification of a failed fuel assembly. Radiocesium decays by beta emission to a metastable nuclear isomer of barium, ^{137m}Ba. Metastable barium has a half-life of about 153 seconds and is responsible for all of the gamma ray emissions associated with ¹³⁷Cs as it decays to the ground state (¹³⁷Ba) by emission of photons.

In some embodiments, the sodium background radiation is reduced to allow a more accurate measurement of the gamma emissions from the ¹³⁷Cs, which may be done by isolating a sodium coolant sample in the sampling sub-cell 406 for a predetermined period of time. The gamma emissions will pass through the piping in the sampling sub-cell 406 and reach the detector 416. The detector can then identify the activity of both the ¹³⁷Cs and ¹³⁴Cs to determine the burnup of the failed fuel assembly. However, in some cases, the background radiation may be characterized, such as prior to gamma testing, and the background radiation may be subtracted out of the gamma spectroscopy results to increase the resolution of the isotopic ratio.

According to some embodiments, determining the fuel assembly burnup by isotopic ratios allows the identification of a failed fuel assembly without unique tag gases in each fuel assembly. In some nuclear reactor embodiments, upwards of 168 or more fuel assemblies may be present in the core, which would thus require unique tag gases. In some embodiments, batches of fuel may be separated by burnup, which allows efficiencies when combined with a tag gas system that reuses tag gases for a group of fuel assemblies. For example, by separating fuel assemblies by burnup, a fewer number of tag gases may be used, such as 28 rather than 168 to distinguish failed fuel assemblies by coupling the failed fuel assembly tag gas identification with the isotopic ratio and burnup. In determining a location of a failed fuel assembly, the batch of the failed fuel assembly can be determined by a tag gas, and the cesium isotopic ratio provides additional information for identifying the failed fuel assembly. For example, the ratio of the number of unique tag gases to the number of fuel assemblies may be less than 50%, or 40%, or 30%, or 20%, or 17% or less. As an example, in a reactor core containing 168 fuel assemblies, 28 unique tag gases may be inserted into the fuel elements during manufacture. When a fuel element fails, an analysis of the cover gas will identify a tag gas, which in turn, down samples the number of possible fuel assemblies by identifying the group to which the failed fuel assembly belongs, thus narrowing the identification of the fuel assembly to one of 6 possible fuel assemblies. Similarly, if only 6 unique tag gases are used during fuel manufacture, the presence of a tag gas in an analysis of the cover gas will narrow the identification of the failed fuel assembly to at least one of 28 fuel assemblies. An analysis of the primary coolant can be used to ascertain the isotopic ratio, which then provides the burnup of the failed fuel assembly. By down sampling the number of possible fuel assemblies that failed, and by further down sampling the number of possible fuel assemblies by burnup, reactor modeling and core tracking can be used to identify the specific failed fuel assembly with a known location within the reactor core. Additionally, once the down selected fuel assemblies are determined, further analysis can be performed on the likely failed fuel assemblies. For example, once the number of failed fuel assemblies has been down sampled, an additional inspection technique, such as a lift and burp technique, may be employed to ascertain which of the likely failed fuel assemblies has actually failed. A lift and burp technique is essentially a sipping technique where a core assembly may be lifted out of its location and gas pressure may be increased, such as by applying a vacuum, blocking a port of the core assembly, or otherwise which causes gas from within the core assembly to escape from the core assembly (e.g., “burp”). This provides substantial improvements in efficiencies over prior processes, which typically must inspect each fuel assembly throughout the core to determine which assembly has failed.

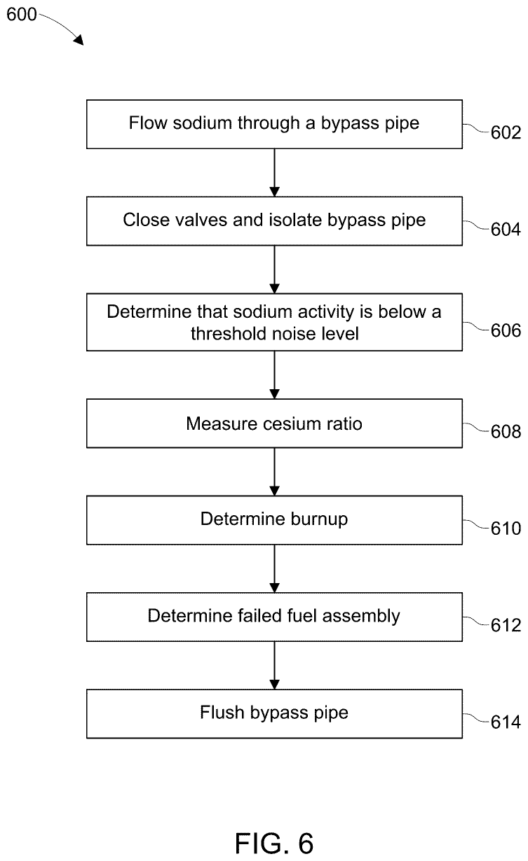

FIG. 6 illustrates a process flow for identifying and locating a failed fuel assembly 600. At step 602, primary sodium flows through a bypass pipe. The bypass pipe may optionally include a cesium trap which may be used to concentrate the cesium to allow for a larger signal. The bypass pipe may be located in a sodium processing cell, and may be located in sampling sub-cell within the sodium processing cell.

At step 604, the sodium sample may be isolated, such as by closing one or more valves to isolate the sodium sample from the sodium flow loop. This allows the sodium sample to remain stationary in the bypass pipe and provides time for the short-lived decay products to disperse. A detector can be in proximity to the pipe such that it can detect emissions from the sodium sample. In some example embodiments, the detector is used to measure isotopic ratios once the sodium enters the bypass pipe without providing time for the short-lived decay products to disperse. In some example embodiments, the sodium is allowed to flow continuously, and the detector is used to measure isotopic ratios of the flowing sodium stream. In some cases, measuring the isotopic ratios in a flowing stream of sodium ameliorates the need for a bypass pipe and the detector may be placed in proximity of the sodium loop without requiring a bypass pipe.

At block 606, the method may include determining that the high-energy sodium activity is below a threshold noise level. This provides that short-lived isotopes, such as ²⁴Na for example, decay to reduce the background signals prior to measuring the isotopic cesium ratios. This may be done, for example, by isolating the sodium sample for a predetermined period of time. Of course, as explained above, the previous steps are optional and, in some cases, the flowing sodium is measured to ascertain the isotopic cesium ratios, which may ameliorate the need for a bypass pipe and valves to isolate the bypass pipe all together and the detectors may be located near a sodium pipe and can continuously measure the isotopic ratios of the flowing sodium.

At block 608, the detector may be used to measure the isotopic cesium ratios. In some cases, this includes the ratio ¹³⁷Cs/¹³⁴Cs. In some embodiments, a mass spectrometer is used to measure the isotopic ratios. In some embodiments, a gamma detector is used to determine the isotopic ratio. The detector may be any suitable detector, such as, without limitation, a radiation dosimeter, radiographic films (e.g., NaI scintillation detector), thermoluminescence detector (TLD detector), a diode detector, high purity germanium detector (HPGe detector), or some other suitable gamma radiation detector.

At block 610, the isotopic ratio can be correlated with fuel element burnup. This may be done, for example, by a specialized computer program executed by one or more processors to determine, based on the isotopic ratios, a burnup, which may be an average burnup, peak burnup, or actual burnup of a fuel assembly.

At block 612, the burnup can be used to determine a failed fuel assembly. Through modeling and core tracking, the burnup of each fuel assembly can be ascertained, which can be compared with the burnup of the failed fuel assembly to thereby identify the failed fuel assembly along with its location within the reactor core. In some cases, a tag gas may be used to narrow the possible failed fuel assemblies, and the burnup can provide further information to narrow the identification of the failed fuel assembly. The number of unique tag gases may be less than the number of fuel assemblies.

At block 614, the bypass pipe may be flushed, such as by opening one or more valves, to allow the sodium sample to return to the sodium loop and back to the reactor. One particular advantage of fuel characterization through gamma spectroscopy, as described, is that it alleviates the traditional steps of shutting down the reactor and either withdrawing samples of radioactive sodium from the reactor vessel or withdrawing fuel assemblies from the core. As described herein, the systems and methods allow failed fuel characterization to be performed in-situ and while the reactor is operating without removing primary coolant from the system.

Once a failed fuel assembly has been identified, it can be scheduled to be replaced during scheduled reactor downtime rather than having to interrogate each of the fuel assemblies to find the failed assembly, find a suitable replacement, recalculate the core loading, approve the new core loading and then replace the fuel assemblies, which takes a significant amount of time during a shutdown, as would be required of traditional systems.

Identifying that a failure has occurred is routine and may be achieved by sampling the cover gas for the presence of fission products. During sampling of cover gas (either periodic or continuous), a reactor operator may learn that a fuel assembly has failed, such as by detecting fission products in the cover gas. The disclosed methods may then be carried out to determine which fuel assembly has failed. The disclosed system and methods allow the identification of the specific failed fuel assembly through detecting the isotopic ratios, determining burnup, and through computational modeling and core tracking, determine the fuel assembly having the determined burnup. In some cases, a tag gas may optionally help to down sample the number of likely candidates.

In some embodiments, the identity of the failed fuel assembly may not be ascertained, but rather, the information gathered from the burnup determination may down sample the likely candidates to fewer than all of the fuel assemblies in the core. In some cases, the techniques described herein may down sample the likely candidates to fewer than 50%, or fewer than 25%, or fewer than 10%, or fewer than 5% of all the fuel assemblies in the core. In these cases, an additional step may be taken to identify the specific failed fuel assembly. For example, once the fuel assemblies are down sampled, the candidate fuel assemblies may be lifted from the core which decreases the hydrostatic pressure and effectively increases the relative pin pressure, and may also reduce forced coolant flow through the assembly which thereby increases the temperature and relative pressure within the fuel elements within the fuel assembly. The increased pressure differential across the breach will cause fission products to be expelled through the cladding, and thus allow the identification of the failed fuel assembly. This process may be repeated for each candidate fuel assembly until the failed fuel assembly is identified. In some cases, this approach is known as a “lift-and-burp” technique. In some cases, the lift-and-burp technique may be applied during a refueling operation.

Although the foregoing description describes a fast sodium-cooled reactor, this is for example purposes only and any solid fueled fission reactor may be used as appropriate.

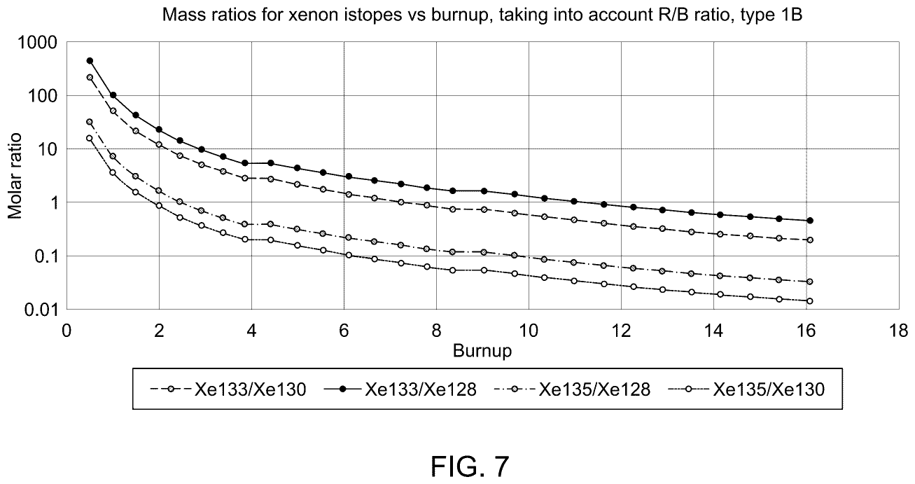

FIG. 7 is a graph of mass ratios of xenon isotopes as a function of burnup. This illustrates the radioactive to nonradioactive ratio of key xenon isotopes. During irradiation in the core, fission gases will be generated, and different isotopes will be present in the fuel element. When a fuel element fails, the fission gases are released into the cover gas, which can be detected according to embodiments described herein. A radioactive and stable isotope of Xe may be released from a failed fuel element and their ratio can be compared. The stable isotope does not decay; therefore, its inventory is increasing linearly with burnup, which is in contrast with a radioactive isotope, which will reach an equilibrium concentration where each atom that decays is replaced by a new one from fission. Not all of the inventory is released from the fuel pin as it must migrate out of the fuel, up the column and out of the pin. The fraction of gas that makes it to the cover gas space relative to how much is actually generated by fission is referred to as the release to birth ratio (“R/B”). The shorter the half-life, the lower the R/B. Therefore, the R/B ratio is taken into account when determining the ratio of stable and radioactive isotopes generated versus what is measured.

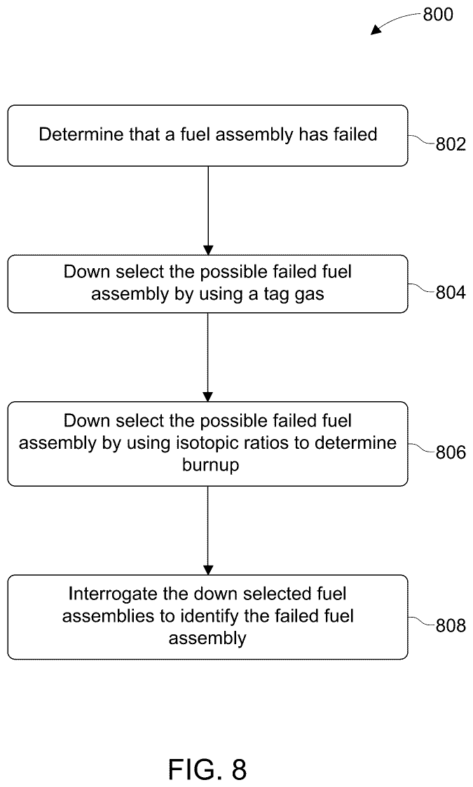

FIG. 8 illustrates a process for identifying and locating a failed fuel assembly 800 within a nuclear reactor core. According to some embodiments, a method includes, at block 802, determining that a fuel assembly has failed. This may be performed through any suitable process, and in some cases, may be determined by analyzing a cover gas for fission products.

At block 804, the first subset of fuel assemblies can be further down sampled to a second subset of fuel assemblies based upon a tag gas. As described, a tag gas may be used within fuel elements and as the tag gas is detected, it can be used to down sample the likely failed fuel assemblies. As described elsewhere herein, unique tag gases may be used within groups of fuel assemblies. For example, a first tag gas may be used in a first group of fuel assemblies, a second tag gas may be used in a second group of fuel assemblies, and a third tag gas may be used in a third group of fuel assemblies. This may provide a way to down sample the potential failed fuel assemblies to a first subset of fuel assemblies that are associated with the detected tag gas.

At block 806, the candidates for the failed fuel assembly are down selected by using isotopic ratios to determine burnup. The burnup can be correlated to a second subset of fuel assemblies that have the approximate burnup associated with the failed fuel assembly. As a non-limiting example, the failed fuel assembly will cause cesium to enter the primary coolant. The primary coolant can be analyzed, such as through gamma spectroscopy, to determine the cesium isotopic ratio, which can be correlated to fuel burnup in the failed fuel assembly. By down sampling the likely failed fuel assemblies through tag gas identification to a first subset, the first subset can be further down sampled to a second subset by determining isotopic ratios of the failed fuel assembly. In some cases, the second subset will include a single fuel assembly, which will be the failed fuel assembly. In some cases, the second subset will identify a number of fuel assemblies that may have failed. In this case, as shown at block 808, the fuel assemblies in the second subset can be interrogated to identify the failed fuel assembly. For example, the fuel assemblies in the second subset can be lifted and burped, or have some other investigative technique used, to determine which fuel assemblies of the second subset have failed.

In some cases, an active isotope of the coolant material provides a higher radioactivity than those of dilute constituents. As an example, in a sodium-cooled fast reactor, ²⁴Na may have a higher abundance than other constituents, such as ¹³⁷Cs or ¹³⁴Cs. As a result, characterization of the coolant by gamma spectroscopy may not be able to discern the presence of cesium due to the large activity of ²⁴Na that scatters to lower activities and may mask lower energy peaks. Moreover, cesium has significant volatility relative to sodium over temperature ranges between the boiling points of the two components. Therefore, in some cases, distillation of the cesium-sodium mixture offers an opportunity for enhancement of the cesium concentration, spectroscopic analysis, and high confidence correlation to a feed concentration, such as that sampled from the coolant pool.

Therefore, in some cases, distillation depends on the chemical thermodynamics of a mixture and the reliability of the distillation equipment. The thermodynamic properties of the components are intrinsic and are therefore constant, concentration enhancement may be performed through distillation, which dramatically increases the concentration of the substances of interest.

Distillation is a separation process used to concentrate or purify components within a mixture based on their differences in boiling points. It exploits the principle that when a mixture is heated, the components with lower boiling points vaporize more readily than those with higher boiling points.

As used herein, the term ‘bottoms product’ or ‘bottom product’ refers to the liquid stream withdrawn from the bottom of the distillation column that contains the less volatile components of the feed mixture. In the sodium-cesium separation described herein, the bottoms product comprises primarily liquid sodium with reduced concentrations of volatile components such as cesium, rubidium, and other volatile fission products. The bottoms product typically maintains a temperature near the reboiler temperature (650° C.-750° C.) and contains components with boiling points higher than the column operating temperature. While the distillate is enriched in volatile components, the bottoms product may be depleted in these components relative to the feed concentration. The bottoms product is typically recycled to the primary coolant inventory after analysis.

The distillation process typically involves a distillation column, which is a vertical vessel containing a series of trays or packing material. The mixture to be separated, known as the feed, is introduced into the column. Heat is applied to the column, causing the mixture to vaporize. As the vapor rises through the column, it comes into contact with either the trays or the packing material, depending on the column design.

The key mechanism driving separation in distillation is the equilibrium established between the vapor and liquid phases of the components in the mixture. As the vapor rises, it becomes enriched in the components with lower boiling points, while the liquid phase becomes enriched in the components with higher boiling points. This process is repeated as the vapor and liquid phases continuously exchange components as they move up and down the column.

At the top of the column, the vapor, now enriched in the more volatile components, is condensed back into a liquid by cooling. This condensed liquid, known as the distillate, is collected. Similarly, at the bottom of the column, the remaining liquid, known as the bottoms product, is withdrawn. The distillation process can be operated in either continuous or batch mode.

In some of the examples described herein, the feed may include sodium and other constituents. The sodium has a boiling point of about 883° C. while cesium has a boiling point of about 671° C. By controlling factors such as temperature, pressure, and reflux ratio (the ratio of condensed vapor returned to the column to the amount of vapor leaving the column), it is possible to achieve the desired level of separation and concentration of the components within the mixture. Distillation is an efficient and repeatable technique for the separation and concentration of cesium in order to produce meaningful gamma spectrographic results.

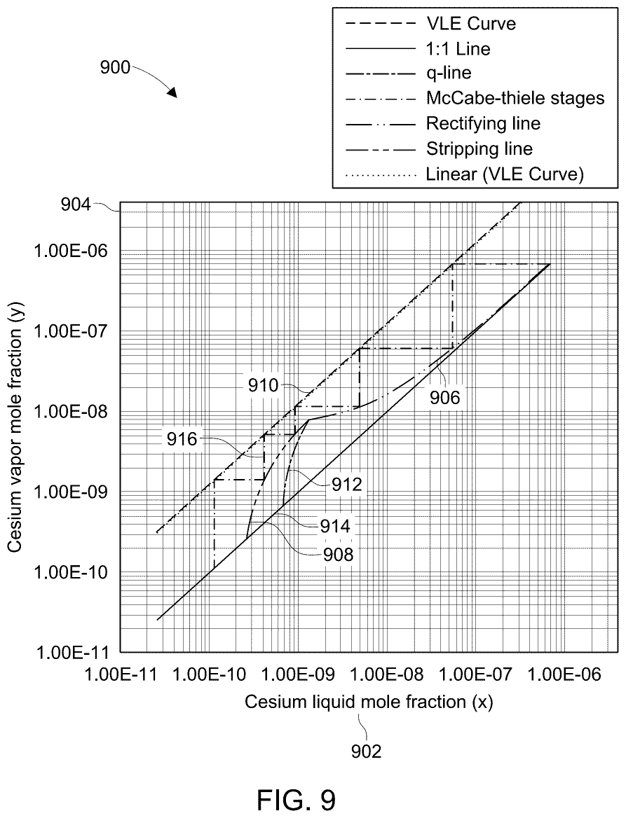

In some cases, distillation enhances the concentration of dilute constituents such that their presence may be more readily detected and quantified, and in some cases, improves their presence by a factor of 10³ or more (i.e., three orders of magnitude). In some cases, the distillation process may be operated to separate various constituents present in the feed. For instance, in some cases, the feed is primary coolant from a nuclear reactor that may contain sodium as a bulk component along with other dilute constituents. According to some examples, dilute constituents in the feed may be separated from sodium such as by using a distillation process with the appropriate equipment. Where it is desirable to separate cesium from the feed, the system may be operated to increase the temperature of the feed to any suitable temperature, which may be close to the boiling point of cesium, sodium, or some other temperature. In some cases, at a suitable temperature, the cesium (or other constituents) will start to boil off and become a vapor, which rises in the distillation column. As it rises, it cools and condenses and at least a portion of the vaporized cesium can be separated as a liquid with the distillate. While it should be appreciated that sodium may be present in the distillate as the bulk component, the concentration of cesium in the distillate is much higher than in the feed. Through the various McCabe-Thiele stages (916 of FIG. 9), the cesium can be concentrated from a mole fraction of 1×10⁻¹⁰ to a mole fraction of about 1×10⁻⁶, or 3-4 orders of magnitude more concentrated. The feed quality may be set to a value of approximately 1.1 in FIG. 9 to achieve the desired separation, though these values can be modified. The feed quality is a quantitative indicator of the condition: superheated vapor q<0, saturated vapor q=0, mixture of liquid and vapor 0<q<1, saturated liquid q=1, sub-cooled liquid q>1. Varying these conditions will have implications for the heat duty and condenser duty as well as the number of stages required for a separation.

Some prior approaches relied on reticulated vitreous carbon (RVC) traps to capture cesium followed by gamma spectroscopy to determine the presence of the cesium isotopes. However, RVC traps rely on accumulated material over time, and often do not produce results with high fidelity with regard to detecting real time concentrations of cesium such that one may identify ratios of cesium isotopes in the feed with confidence.

In some cases where it is desirable to detect concentrations of cesium with a high degree of confidence, the short-lived isotopes may require time to decay in order to gain a higher confidence in the amount of dilute constituents present. In many cases, the time between sampling and measuring may be on the order to 3-5 days or more. In many cases, this delay between sampling and measuring exacerbates issues from a leaking fuel element. It is preferable to detect a leaking fuel element and begin the identification process sooner, rather than waiting days or even weeks to characterize a failed fuel assembly.

Therefore, in some embodiments, cesium may be concentrated relative to sodium so the gamma flux of the cesium peaks is distinguishable from the ²⁴Na scatter. Specifically, ²⁴Na activation in the primary coolant results in high activity that obscures the gamma signal from other radioisotopes and scatter from ²⁴Na creates a substantial background source that overlaps with the gamma energy signature of ¹³⁷Cs and ¹³⁴Cs. Even though the ²⁴Na gamma energy peak may be distinct from those of ¹³⁴Cs and ¹³⁷Cs, the ²⁴Na activity magnitude is so much higher that the scatter to lower energies often obscures the cesium signals.

Concentrating the cesium, in some examples, leads to three orders of magnitude increase for the ¹³⁷Cs gamma flux at its peak energy, which makes it to be about the same magnitude as scatter from ²⁴Na.

According to some embodiments, a continuous distillate stream may increase the initial sample concentration of cesium. The equipment and heat requirements are relatively low in comparison with the benefits of such a process.

In some cases, a sample flow rate on the order of 0.1 gpm (0.38 lpm) is sufficient to concentrate the cesium by three orders of magnitude. This is a generally low rate and the systems and methods described herein are able to generate accurate measurements at such a low flow rate. The system geometry of the distillation equipment, at least in part, determines the residence time for the feed to be distilled and constituents of the feed to be separated out. Depending on the geometry of the distillation equipment, the time from an incoming feed of primary coolant to distilling constituents present in the feed and obtaining concentration measurements relies may be on the order of less than two hours, or less than one hour, or less than 45 minutes, or less than 30 minutes, or less than 15 minutes, or less than 10 minutes, or less than 5 minutes. Of course, by varying the geometry of the distillation equipment, the residence times may be increased or reduced. This is in contrast to some prior measurement methodologies that must wait for the ²⁴Na to decay in order to reduce the background scatter in order to accurately measure the cesium isotopes. This process, in many cases, may take days such as 3-4 days on average in order to gather a meaningful measurement with sufficient accuracy.

As used herein, “near real-time” with respect to concentration determination means obtaining quantitative measurements of dilute constituents within 2 hours of the primary coolant entering the distillation apparatus, and more preferably within 30 minutes, and most preferably within 10 minutes. This timeframe encompasses the residence time in the distillation column, transport time to the detector, and counting time required for statistically significant measurements. This is in contrast to traditional methods requiring 72-96 hours for ²⁴Na decay before meaningful cesium measurements can be obtained.

“Continuous sodium coolant stream” refers to an uninterrupted flow of primary coolant through the distillation apparatus at flow rates between 0.05 and 0.5 gallons per minute (0.19 to 1.9 liters per minute). The continuous nature of the flow enables steady-state operation of the distillation column and provides representative sampling of the bulk primary coolant inventory. The system may operate with flow variations of +20% without significantly affecting separation efficiency.

“Determining a concentration” encompasses both qualitative detection (presence/absence) and quantitative measurement of specific isotopes or elements. For cesium isotopes, concentration determination includes measuring absolute activities (Bq/mL), mass concentrations (μg/L), and isotopic ratios (¹³⁷Cs/¹³⁴Cs) with measurement uncertainties less than 10%. The determination may be performed using gamma spectroscopy, mass spectrometry, or other analytical techniques capable of isotope-specific measurements.

“Passing the distillate or the bottoms product by a detector” includes configurations where the process stream flows through detection piping adjacent to the detector, flows through a measurement cell viewed by the detector, or is diverted to a sampling loop for measurement. The detector placement provides sufficient counting geometry to achieve the required detection limits while maintaining process flow.

Furthermore, through the concentration techniques described herein, the cesium inventory within the sodium coolant can be tracked which provides information related to the magnitude of fuel assembly failures, and can also be used as a secondary measurement in case the cesium traps reach breakthrough or equilibrium conditions. In addition, the chemical constituents of the primary coolant can be quickly determined, and can also be used to monitor mitigation efforts when failed fuel assemblies are replaced.

The distillation apparatus described herein provides for near real time results as cesium can be concentrated based on thermodynamic parameters based on volatile species and results can be obtained immediately. As used herein with respect to the process of distillation and concentrating, near real-time refers to a process that allows measurement of the desired constituents present in the feed without a requirement of waiting for sodium to decay. This process thus allows for determining the constituents of the primary coolant at any time, concentrating constituents based on relative volatility will provide immediate feedback which may also be important data for later plant design and/or operation, and it will provide long term data feedback regarding mitigation efforts to slow or stop leakage.

FIG. 9 illustrates a McCabe-Thiele Diagram 900 showing the vapor-liquid equilibrium of cesium. The McCabe-Thiele diagram 900 is a graphical method used in chemical engineering to analyze binary distillation processes. It can be used to understand the separation efficiency and determine the number of theoretical stages required for a given separation task. As shown, the diagram 900 displays the distillation process and can be used to determine the number of theoretical stages required to achieve a desired degree of separation between two components in the binary mixture.

The dilute nature of the desired separations may allow one to conduct McCabe Thiele calculations to assess the separation impact on individual species without considering multicomponent distillation methods. This is essentially because when the desired species in the sodium are at their enhanced concentration, they're still so dilute that they do not significantly contribute to the bulk phase enough to change the bulk fluid thermodynamics. This is not to say that one should not consider the enhancement of other elements, they will all change concentration from the feed concentration by going through the distillation process, but those changes will not meaningfully influence the thermodynamics of other dilute constituents. In some cases, the thermodynamic activity coefficient of dilute species in solution will be considered constant for each species, and equal to their respective values at the “infinite dilution” approximation.

As illustrated, the x-axis 902 represents the mole fraction of liquid cesium while the y-axis 904 represents the mole fraction of the cesium vapor.

The diagram 900 includes two operating lines, the rectifying line (R-Line) 906 that represents the composition changes occurring during vaporization in the distillation column and the stripping line (S-Line) 908 that represents the composition changes during condensation or stripping in the distillation column.

The vapor-liquid equilibrium curve 910 represents the equilibrium relationship between the liquid and vapor phases at a given pressure and temperature which shows how the composition of the liquid and vapor phases change as the distillation progresses.

The diagram provides valuable information such as the number of theoretical stages required for the separation, the reflux ratio needed to achieve the desired separation, the composition profiles of the distillate and bottoms streams, and operating conditions for the distillation column. The q-line 912 intersects the point of intersection of the feed composition line and the x=y line 914 and has a slope of q/(q−1), where q denotes the mole fraction of liquid in the feed.

The McCabe-Thiele diagram 900 provides design information for the distillation apparatus. The intersection of the rectifying line 906 and stripping line 908 occurs at the feed stage location, which determines the optimal point for introducing the sodium coolant feed into the column. The vertical distance between the operating lines and the equilibrium curve 910 represents the driving force for separation at each stage. A larger distance indicates more efficient separation, while regions where the operating lines approach the equilibrium curve represent pinch points that may limit separation efficiency.

The five theoretical stages shown by curve 916 translate to practical design requirements. In implementation, actual stages may range from 7 to 10 to account for stage efficiency factors typically ranging from 50-70% for sodium-cesium systems. The reflux ratio, determined by the slope of the rectifying line 906, affects both the separation quality and energy requirements. Higher reflux ratios improve separation but increase reboiler and condenser duties. For the cesium-sodium system, optimal reflux ratios typically range from 1.5 to 3.0 times the minimum reflux ratio.

The feed quality parameter q influences the thermal condition of the feed entering the column. For this application, maintaining q slightly above 1.0 (sub-cooled liquid) provides operational stability and prevents vapor flashing that could disturb column hydraulics. The composition profiles derived from the diagram indicate that cesium concentration in the distillate can achieve enhancement factors of 10³ to 10⁴ relative to the feed concentration, enabling detection of cesium isotopes even at ppb levels in the primary coolant.

As illustrated, the diagram 900 indicates that five stages are required for theoretical separation, shown by the McCabe-Thiele Stages curve 916.

Based upon the theoretical stages illustrated in the diagram 900, an apparatus can be constructed to carry out the distillation process.

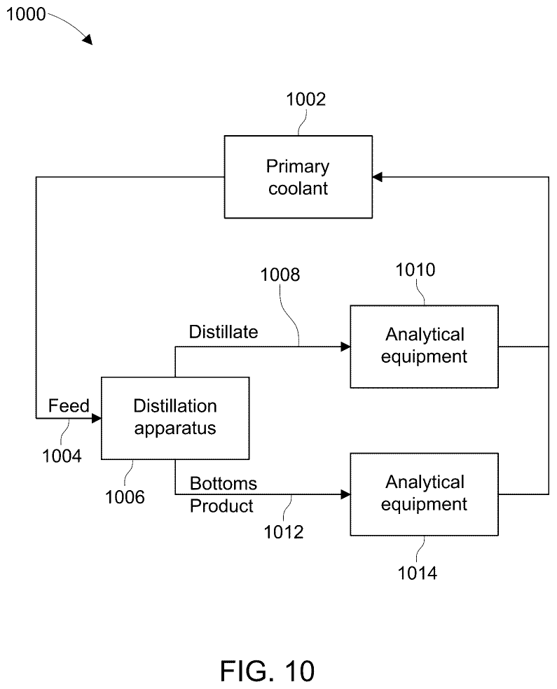

FIG. 10 illustrates a sample apparatus 1000 for distilling and concentrating cesium, in according with some embodiments. In a basic sense, the primary coolant inventory 1002 may include sodium and a volume of cesium. A portion of the primary coolant (i.e., the feed 1004) is fed to a distillation apparatus 1006 configured for distilling cesium from sodium. The distillation apparatus 1006 is operated to change at least a portion of the cesium in the distillate into a vapor, such as by heating, and the distillate 1008 may be directed to analytical equipment 1010 in order to quantify the cesium, which in some cases, results in an isotopic ratio of ¹³⁷Cs to ¹³⁴Cs. More specifically, the distillation apparatus will incrementally increase the equilibrium vapor pressure of cesium in each tray going up the distillation column, such that the highest cesium vapor pressure is in the top tray. Though the vapor phase will still be almost entirely sodium, it will contain a high cesium content relative to what the vapor pressures overhead the feed stream would have been. The analytical equipment 1010 may be a gamma spectrometer that is configured to analyze the gamma energy emanating from the isotopes passing therethrough. In some embodiments, analytical equipment 1014 may be configured to analyze the bottoms product 1012 for components that are less volatile than sodium that concentrate in the bottoms rather than the distillate. This dual analysis capability enables comprehensive characterization of the primary coolant composition.

In some cases, one or more cesium traps may be provided to capture and remove the cesium from the system. The distillation apparatus 1006 may further be configured to direct the bottoms product 1012, which may include sodium, to further analytical equipment 1014 such as for quantifying components present in the bottoms product, or other purposes. The sodium may then be directed back to be returned to the primary coolant 1002 inventory. In some cases, the cesium may likewise be returned to the primary coolant inventory, although in other cases, the cesium may be removed from the system, such as by a cesium trap, by oxidizing the cesium to facilitate solids capture, or otherwise. Of course, the analytical equipment 1010 may be used to quantify or otherwise measure components other than cesium.

In some cases, the systems and methods described herein may be used to evaluate constituents of the bottoms product. For instance, the distillation systems described herein may separate some of the more volatile constituents from the feed stock and leave the bottoms product that may have a higher concentration of constituents of interest. In this way, the methods described herein may be used to concentrate, quantify, and/or analyze constituents found either in the distillate or bottoms product and the system geometry, flow, temperature, and column structure may determine whether the constituent of interest is separated into the distillate or the bottoms product.

While the disclosure uses cesium and its isotopes as an example constituent of interest, it should be apparent that other constituents can be concentrated and analyzed and some of the constituents of interest may be less volatile and will therefore be found in the bottoms product existing the distillation column. Other example constituents that may be concentrated in either the distillate or the bottoms product include, without limitation, cesium, rubidium, cadmium, iodine, barium, bromine, lithium, and potassium, among others.

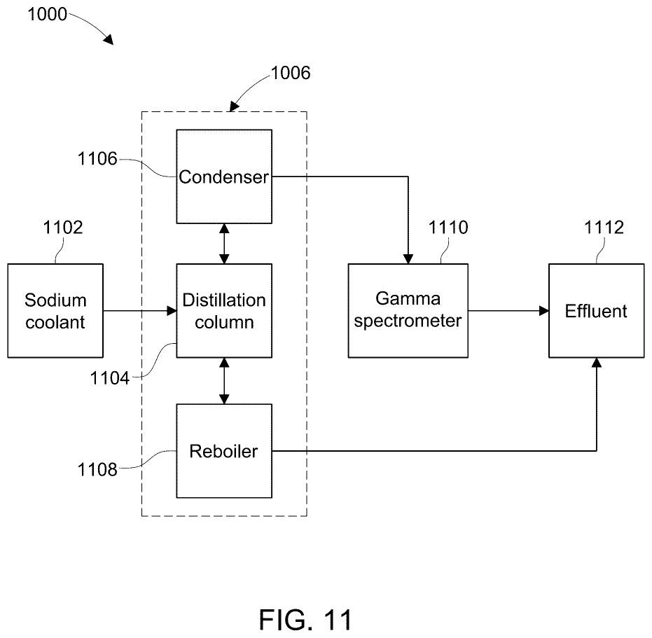

FIG. 11 illustrates a sample apparatus and fluid flow, according to some embodiments. Sodium coolant 1102 may be provided as a feed into a distillation apparatus 1006 shown in the dotted box. The sodium coolant may be directed from a nuclear reactor vessel, where the sodium coolant is used as a primary coolant. The distillation apparatus 1006 may include a distillation column 1104, a condenser 1106 and a reboiler 1108. As the sodium coolant feeds into the distillation apparatus, the sodium coolant is heated by the reboiler 1108 and the cesium within the sodium coolant is vaporized and travels up the distillation column 1104 until it is condensed at the condenser 1106. The distillation apparatus 1006 is thus able to separate the cesium from the sodium based upon their differing boiling points. The cesium is now concentrated and can be sent to the gamma spectrometer 1110 for analysis. In some cases, the initial concentration of cesium in the sodium coolant provides diagnostic data, including ascertaining whether a fuel assembly has failed, and to what degree, whether mitigation efforts such as identifying and removing a failed fuel assembly have been successful, determining an isotopic ratio of the cesium in the sodium coolant which may be used to determine the burnup of the failed fuel assembly, and other purposes. As described herein, the isotopic ratio of ¹³⁷Cs to ¹³⁴Cs can be used to determine nuclear fuel burnup, which can further be used to identify a failed fuel assembly within the reactor.

In some cases, the distillate (e.g., cesium) is then mixed with the bottoms product (e.g., sodium) and exits the system as effluent 1112. The effluent may be returned to the primary coolant inventory. In some cases, the cesium may be removed from the system and only the bottoms product is returned to the primary coolant inventory.

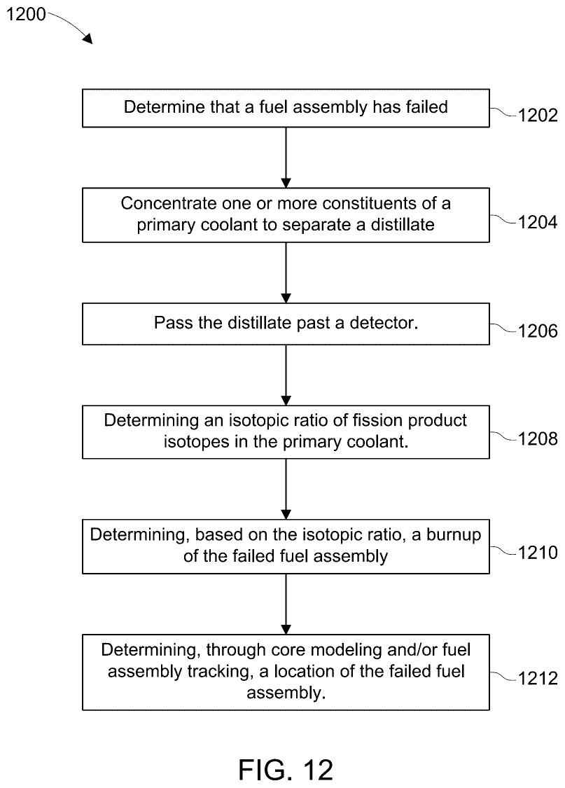

FIG. 12 illustrates a process for identifying and locating a failed fuel assembly 1200 within a nuclear reactor core. According to some embodiments, a method includes, at block 1202, determining that a fuel assembly has failed. This may be performed through any suitable process, and in some cases, may be determined by analyzing a cover gas for fission products, a wet sipping technique, a dry sipping technique (e.g., lift and burp), or some other technique. In addition, determining the constituents of the primary coolant may indicate that a fuel assembly has failed. In some examples, this may be accomplished by detecting cesium in the primary coolant, which may be done in conjunction with block 1204. At block 1204, one or more constituents within the primary coolant are concentrated, such as through a distillation process, as described herein, to separate a distillate. In some cases, the primary coolant comprises sodium and the constituent to be condensed is cesium, and thus the distillate from the distillation process may be cesium. Typically, radioactive sodium (e.g., ²⁴Na) displays a large section of gamma flux scatter, which obscures the cesium peak energy gamma flux. Therefore, according to some embodiments, the cesium (e.g., ¹³⁷Cs and/or ¹³⁴Cs) may be concentrated relative to sodium by three orders of magnitude in order for the ¹³⁷Cs gamma flux at its peak energy to have a similar magnitude as scatter from the ²⁴Na. In some cases, the concentration may be carried out to less than three orders of magnitude, such as 2.5, or 2, or 1.5 or some other order of magnitude in order to disseminate meaningful results through gamma spectroscopy.

At block 1206, the sample of distillate is caused to flow adjacent a detector, which in some cases, is a gamma spectrometer. In some cases, the distillate stream may be a continuous stream, while in other cases, a portion of the fluid stream may be directed to the detector without using a continuous stream process. The detector may be used, for example, to determine that a fuel assembly has failed, such as by indicating the presence of cesium in the sodium primary coolant. The detector may alternatively or additionally be used to determine the effect of prior mitigation efforts in relation to a failed fuel assembly. For example, where a failed fuel assembly has been replaced, the detector can be used to determine whether the correct fuel assembly was replaced by tracking the cesium inventory within the coolant over time. Moreover, the detector can be used to ascertain the effectiveness of one or more cesium traps by monitoring the levels of cesium within the primary coolant over time. In some cases, the detector may optionally be used to determine isotopic ratios, and concomitant burnup of a failed fuel assembly.

At block 1208, the method optionally includes determining an isotopic ratio of fission product isotopes in the primary coolant. This may be performed by any suitable technique, such as any of the techniques described herein in relation to the various embodiments disclosed.

At block 1210, the method optionally includes determining, based on the isotopic ratio, a burnup of the failed fuel assembly. In some cases, the burnup can be correlated to a first subset of fuel assemblies that have the approximate burnup associated with the failed fuel assembly. As a non-limiting example, the failed fuel assembly will cause cesium to enter the primary coolant. The primary coolant can be analyzed, such as through gamma spectroscopy, to determine the cesium isotopic ratio, which can be correlated to fuel burnup in the failed fuel assembly.

At block 1212, the method may optionally determine a location of the failed fuel assembly, which can be performed by using core modeling and/or fuel assembly tracking during the fuel cycle of the nuclear reactor core. Further steps may be included, for example, using a tag gas to down select, or specifically identify, the failed fuel assembly. In some cases, the suspected failed fuel assemblies may be individually interrogated to determine which one or ones of the suspected fuel assemblies has failed.

It should be appreciated by those of skill in the art that there are numerous benefits achievable by the systems and process described herein. Notably, in addition to aiding in identifying a failed fuel assembly, the systems and methods also allow for identification of chemical constituents of the primary coolant as a diagnostic indicator. Moreover, the inventory of primary coolant constituents can be tracked over time, including how the constituents change over time, such as by comparing the primary constituent components at a first time with the primary constituent components at a second time. In some cases, the primary constituent components can be quantified as a continual process with a steady stream of feed to the distillation apparatus and a steady distillate stream and bottoms product exiting the distillation equipment and analyzed. Furthermore, the magnitude of fuel failures can be ascertained by interrogating the primary coolant as described. In addition, the described systems and methods allow for identification of when a cesium trap in the reactor system has reached breakthrough or equilibrium, that is, when the cesium trap is full and is ready to be replaced. Furthermore, interrogating the primary coolant as described allows a verification that mitigation efforts have been successful, such as by replacing a failed fuel assembly. In all cases, the distillation apparatus allows for immediate and real time results. As used herein, real time results are those that are obtained as quickly as the gamma spectrometer can process the sample, which can be performed without waiting for the sodium to decay and reduce its background scatter. In some cases, determining results in real time means that results are obtained in less than two hours after the sodium coolant stream is received at the distillation apparatus, or less than one hour, or less than thirty minutes, or less than fifteen minutes, or less than ten minutes, or less than five minutes. The techniques described herein allow sampling and measurements to happen on the order of minutes, or seconds, while prior efforts that require background scatter to subside, take hours or even days to achieve meaningful results. In some cases, a continuous stream of sodium coolant is continually distilled, and the distillate can be quantified on an ongoing basis, resulting in continuous measurements associated with the distillate. This allows the distillate to be quantified over time and can present changes in the distillate within the sodium coolant.

Consequently, the systems and methods described herein allow diagnoses of constituents in the primary coolant at any given time; concentrating constituents based on relative volatility provides immediate feedback, and long-term data on mitigation efforts.

Of course, the processes and operations described herein need not be performed in the illustrated order. For example, a first down sampling may be performed by tag gas analysis to determine a first subset, and the first subset may then be further narrowed by analyzing for burnup associated with a measured isotopic ratio. In this way, a failed fuel assembly can quickly be ascertained, which in many cases, can be accomplished in-situ (e.g., without having to remove a fuel assembly from the core for testing), and also while the reactor is operating.

The foregoing description of specific embodiments will so fully reveal the general nature of embodiments of the disclosure that others can, by applying knowledge of those of ordinary skill in the art, readily modify and/or adapt for various applications such specific embodiments, without undue experimentation, without departing from the general concept of embodiments of the disclosure. Therefore, such adaptation and modifications are intended to be within the meaning and range of equivalents of the disclosed embodiments, based on the teaching and guidance presented herein. The phraseology or terminology herein is for the purpose of description and not of limitation, such that the terminology or phraseology of the specification is to be interpreted by persons of ordinary skill in the relevant art in light of the teachings and guidance presented herein.

The breadth and scope of embodiments of the disclosure should not be limited by any of the above-described example embodiments, but should be defined only in accordance with the following claims and their equivalents.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language generally is not intended to imply that features, elements, and/or operations are in any way required for one or more implementations or that one or more implementations necessarily include logic for deciding, with or without user input or prompting, whether these features, elements, and/or operations are included or are to be performed in any particular implementation.

Unless otherwise noted, the terms “connected to” and “coupled to” (and their derivatives), as used in the specification, are to be construed as permitting both direct and indirect (i.e., via other elements or components) connection. In addition, the terms “a” or “an,” as used in the specification, are to be construed as meaning “at least one of.” Finally, for ease of use, the terms “including” and “having” (and their derivatives), as used in the specification, are interchangeable with and have the same meaning as the word “comprising.”

The specification and annexed drawings disclose examples of systems, apparatus, devices, and techniques that may provide a repeatable and reliable measure of constituents within a primary coolant stream, where the results may be obtained continuously, in real time, and may further be used as diagnostic data, mitigation data, and fuel assembly identification. It is, of course, not possible to describe every conceivable combination of elements and/or methods for purposes of describing the various features of the disclosure, but those of ordinary skill in the art recognize that many further combinations and permutations of the disclosed features are possible. Accordingly, various modifications may be made to the disclosure without departing from the scope or spirit thereof. Further, other embodiments of the disclosure may be apparent from consideration of the specification and annexed drawings, and practice of disclosed embodiments as presented herein. Examples put forward in the specification and annexed drawings should be considered, in all respects, as illustrative and not restrictive. Although specific terms are employed herein, they are used in a generic and descriptive sense only, and not used for purposes of limitation.

A person of ordinary skill in the art will recognize that any process or method disclosed herein can be modified in many ways. The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed.

The various exemplary methods described and/or illustrated herein may also omit one or more of the steps described or illustrated herein or comprise additional steps in addition to those disclosed. Further, a step of any method as disclosed herein can be combined with any one or more steps of any other method as disclosed herein.

The methods described in relation to embodiments herein may be implemented, at least in part, by one or more processors executing instructions that cause the processors to carry out the disclosed methods.

Throughout the instant specification, the term “substantially” in reference to a given parameter, property, or condition may mean and include to a degree that one of ordinary skill in the art would understand that the given parameter, property, or condition is met with a small degree of variance, such as within acceptable manufacturing tolerances. By way of example, depending on the particular parameter, property, or condition that is substantially met, the parameter, property, or condition may be at least approximately 90% met, at least approximately 95% met, or even at least approximately 99% met.

From the foregoing, it will be appreciated that, although specific implementations have been described herein for purposes of illustration, various modifications may be made without deviating from the spirit and scope of the appended claims and the elements recited therein. In addition, while certain aspects are presented below in certain claim forms, the inventors contemplate the various aspects in any available claim form. For example, while only some aspects may currently be recited as being embodied in a particular configuration, other aspects may likewise be so embodied. Various modifications and changes may be made as would be obvious to a person skilled in the art having the benefit of this disclosure. It is intended to embrace all such modifications and changes and, accordingly, the above description is to be regarded in an illustrative rather than a restrictive sense.

The following numbered clauses also form a part of the disclosure.

Clause 1. A method for online monitoring of radionuclides in a sodium coolant, comprising flowing a continuous sodium coolant stream from a nuclear reactor vessel to a distillation apparatus; distilling one or more constituents of the sodium coolant stream to separate a distillate; passing the product stream from the distillation apparatus by a detector; and determining, with the detector, a concentration of constituents in the product stream from the distillation apparatus.

Clause 2. The method of clause 1, wherein a component in the distillate stream is cesium and wherein determining a concentration of the cesium further comprises determining an isotopic ratio of ¹³⁷Cs/¹³⁴Cs within the sodium and in some cases wherein determining the isotopic ratio is performed by gamma spectroscopy.

Clause 3. The method of any of clauses 1-2, wherein the method is performed without removing primary sodium coolant from a closed system comprising a nuclear reactor vessel and the bypass pipe.

Clause 4. The method of any of clauses 1-3, further comprising determining, based at least in part on the isotopic ratio, a burnup of a failed fuel assembly.

Clause 5. The method of any of clauses 4, further comprising determining, based at least in part on the burnup, an identification of the failed fuel assembly.

Clause 6. The method of any of clauses 1-5, further comprising determining, by analyzing a cover gas in a reactor vessel and detecting a fission product in the cover gas, that a fuel assembly has failed.

Clause 7. The method of any of clauses 1-6, further comprising determining a concentration of constituents in a bottoms product from the distillation apparatus.

Clause 8. The method of any of clauses 1-7, further comprising providing a tag gas to one or more fuel elements within a fuel assembly.

Clause 9. The method of clause 8, wherein providing a tag gas comprises providing a plurality of unique tag gases and wherein a number of unique tag gases is less than a number of fuel assemblies located within a nuclear reactor core.

Clause 10. The method of any of clauses 1-9, wherein the method is carried out during reactor operation.

Clause 11. The method of any of clauses 1-10, wherein determining an identification of the failed fuel assembly comprises determining a subset of fuel assemblies, the subset of the fuel assemblies comprising one or more of the failed fuel assemblies.

Clause 12. The method of clause 11, further comprising analyzing ones of the subset of the fuel assemblies to determine a failed fuel assembly.

Clause 13. The method of clause 12, wherein analyzing ones of the subset of the fuel assemblies comprises a lift and burp technique.

Clause 14. The method of any of clauses 1-13, further comprising isolating the sodium coolant in the bypass pipe.

Clause 15. A system, comprising a nuclear reactor core; a plurality of fuel elements disposed in the nuclear reactor core; a volume of primary sodium coolant in contact with the plurality of fuel elements; a distillation apparatus in fluid communication with the nuclear reactor core by sodium processing piping and configured to concentrate one or more constituents of the primary sodium coolant to separate a distillate; a detector adjacent the sodium processing piping, the detector configured to detect radioactive emissions of one or more components in the distillate that escaped from a failed fuel assembly; and one or more processors configured with instructions that, when executed by the one or more processors, cause the processors to: determine a concentration of the one or more components in the distillate.

Clause 16. The system of clause 15, wherein the one or more processors are further configured to: determine isotopic ratios of the one or more components in the distillate; determine, based at least in part on the isotopic ratios, a burnup of the failed fuel assembly; and determine, based at least in part on the burnup of the failed fuel assembly, a location of the failed fuel assembly within the nuclear reactor core.

Clause 17. The system of clause 16, wherein the isotopic ratio is ¹³⁷Cs/¹³⁴Cs.

Clause 18. The system of clause 15, further comprising a plurality of unique tag gases located within selected ones of the plurality of fuel elements disposed in the nuclear reactor core.

Clause 19. The system of clause 15, wherein the detector is configured to detect gamma emissions from one or more isotopes that escaped from a failed fuel assembly through gamma spectroscopy.

Clause 20. The system of clause 15, wherein at least one of the one or more components in the distillate is cesium.

Clause 21. The system of clause 15, wherein the detector is configured to detect gamma emissions from the isotopes that escaped from a failed fuel assembly through gamma spectroscopy.

Clause 22. The system of clause 15, wherein the distillation apparatus comprises a distillation column configured to operate at a pressure between 1 and 5 torr absolute; a reboiler configured to maintain a temperature between 650° C. and 750° C.; a condenser configured to maintain a temperature between 350° C. and 450° C.; and wherein the distillation column is configured to achieve a concentration enhancement factor of at least 103 for cesium relative to the sodium coolant stream.

Clause 23. The system of clause 15, wherein the one or more processors are further configured to continuously monitor a trend of cesium concentration in the primary sodium coolant over time; detect a rate of change in the cesium concentration; determine, based on the rate of change, whether a fuel assembly failure is progressing or stable; and generate an alert when the rate of change exceeds a predetermined threshold indicative of progressive fuel assembly degradation.

What is claimed is:

1. A method for online monitoring of radionuclides in a sodium coolant, comprising:
flowing a continuous sodium coolant stream to a distillation apparatus;
distilling one or more constituents of the sodium coolant stream to separate a distillate and a bottoms product;
passing the distillate or the bottoms product by a detector; and
determining, with the detector, a concentration of one or more components in the distillate or the bottoms product.

2. The method of claim 1, wherein the one or more components in the distillate or the bottoms product includes cesium and wherein determining a concentration of the one or more components in the distillate or the bottoms product further comprises determining an isotopic ratio of ¹³⁷Cs/¹³⁴Cs.

3. The method of claim 2, further comprising determining, based at least in part on the isotopic ratio, a burnup of a failed fuel assembly.

4. The method of claim 3, further comprising determining, based at least in part on the burnup, an identification of the failed fuel assembly.

5. The method of claim 1, wherein determining the concentration of the distillate or the bottoms product is performed by gamma spectroscopy.

6. The method of claim 1, wherein the method is performed without removing primary sodium coolant from a closed system comprising a nuclear reactor vessel and a sodium flow pipe.

7. The method of claim 1, further comprising determining, by analyzing a cover gas in a reactor vessel and detecting a fission product in the cover gas, that a fuel assembly has failed.

8. The method of claim 1, wherein the method is carried out during reactor operation.

9. The method of claim 1, wherein the step of determining a concentration of the one or more components in the distillate or the bottoms product is performed in near real time without waiting for the sodium to decay.

10. The method of claim 1, wherein the continuous sodium coolant stream flows from a nuclear reactor vessel, wherein the nuclear reactor vessel includes a plurality of nuclear fuel assemblies and further comprising determining a subset of nuclear fuel assemblies of the plurality of nuclear fuel assemblies that includes a failed fuel assembly.

11. The method of claim 10, further comprising analyzing ones of the subset of the nuclear fuel assemblies to determine the failed fuel assembly.

12. The method of claim 11, wherein analyzing ones of the subset of the nuclear fuel assemblies comprises a lift and burp technique.

13. A system, comprising:
a nuclear reactor core;
a plurality of fuel elements disposed in the nuclear reactor core;
a volume of primary sodium coolant in contact with the plurality of fuel elements;
a distillation apparatus in fluid communication with the nuclear reactor core by sodium processing piping and configured to concentrate one or more constituents of the primary sodium coolant to separate a distillate;
a detector adjacent the sodium processing piping, the detector configured to detect radioactive emissions of one or more components in the distillate that escaped from a failed fuel assembly; and
one or more processors configured with instructions that, when executed by the one or more processors, cause the processors to:
determine a concentration of the one or more components in the distillate.

14. The system of claim 13, wherein the one or more processors are further configured to:
determine isotopic ratios of the one or more components in the distillate;
determine, based at least in part on the isotopic ratios, a burnup of the failed fuel assembly; and
determine, based at least in part on the burnup of the failed fuel assembly, a location of the failed fuel assembly within the nuclear reactor core.

15. The system of claim 14, wherein the isotopic ratio is ¹³⁷Cs/¹³⁴Cs.

16. The system of claim 13, further comprising a plurality of unique tag gases located within selected ones of the plurality of fuel elements disposed in the nuclear reactor core.

17. The system of claim 13, wherein the detector is configured to detect gamma emissions from one or more isotopes that escaped from a failed fuel assembly through gamma spectroscopy.

18. The system of claim 13, wherein the one or more components in the distillate includes cesium.

19. The system of claim 13, wherein the distillation apparatus comprises:
a distillation column configured to operate at a pressure between 1 and 5 torr absolute;
a reboiler configured to maintain a temperature between 650° C. and 750° C.;
a condenser configured to maintain a temperature between 350° C. and 450° C.; and
wherein the distillation column is configured to achieve a concentration enhancement factor of at least 103 for cesium relative to the sodium coolant stream.

20. The system of claim 13, wherein the one or more processors are further configured to:
continuously monitor a trend of cesium concentration in the primary sodium coolant over time;
detect a rate of change in the cesium concentration;
determine, based on the rate of change, whether a fuel assembly failure is progressing or stable; and
generate an alert when the rate of change exceeds a predetermined threshold indicative of progressive fuel assembly degradation.
